(19) United States
(12) Patent Application Publication
(10) Pub. No.: US 2026/0358654 A1
(43) Pub. Date: Nov. 12, 2026

(54) METHODS AND APPARATUS FOR ANTI-FOG EYEWEAR USING MICRO-TEXTURED SURFACE

(71) Applicant: John Chen, Alpharetta, GA (US)

(72) Inventor: John Chen, Alpharetta, GA (US)

(21) Appl. No.: 19/204,908

(22) Filed: May 12, 2025

(51) Int. Cl. G02C 11/08

(52) U.S. Cl. CPC G02C 11/08

(57) ABSTRACT

An anti-fog eyewear system according to various aspects of the present technology is configured to provide a surface resistant to fogging while requiring less maintenance. A surface of the device may comprise a micro-textured surface layer configured to create an increase in the hydrophilic nature of the surface layer to prevent formation of individual water droplets and instead form a uniform water film along the entire surface of the eyewear system. The micro-textured surface may be formed of a distribution of pits, protrusions, or grooves, at appropriate dimensions and gaps to create a continuously variable surface to provide at least one region along any individual droplet with a reduced contact angle between any droplet and the surface layer allow water to adhere more evenly along the surface.

### BACKGROUND OF THE INVENTION

Fog on a lens or other surface is caused by water vapor condensing into numerous tiny droplets along the surface. Due to surface tension, these droplets form spherical shapes, creating an uneven surface that disrupts optical clarity through scattering, refraction, and reflection. If a uniform, smooth film of water can be maintained on the lens surface, these small droplets will merge into this film or be washed away by larger water drops flowing on the surface, preserving the optical properties of the smooth surface.

Existing sealed eyewear, such as swimming goggles and diving masks, are designed to form an airtight space when worn. A common problem with this type of eyewear is that fogging may occur on the inner layer that obstructs the vision of the user. Even non-fully sealed eyewear like windshields and goggles can fog up in humid environments or with temperature changes. While fog droplets are small, they can pose significant problems, ranging from inconvenience during swimming, diving, driving, or flying, to potentially reducing efficiency or even causing danger. Current defogging methods typically involve removing the eyewear for wiping, which is inconvenient and may scratch or contaminate the lens or introduce smudging along the surface worsening seeing conditions. Existing anti-fog solutions include various cleaning methods aimed at eliminating particulate matter and the application of anti-fog coatings or sprays designed to reduce the likelihood of the formation of any condensation on the treated surface. The issue with coatings is that they wear off over time. Sprays and other surface treatments may only last a few dozen minutes or a few hours, they need to be reapplied before each use, allowed sufficient time to dry, they are susceptible to smudges, and may irritate the eyes.

### SUMMARY OF THE INVENTION

An anti-fog eyewear system according to various aspects of the present technology is configured to provide a surface resistant to fogging while requiring less maintenance. A surface of the device may comprise a micro-textured surface layer configured to create an increase in the hydrophilic nature of the surface layer to prevent formation of individual water droplets and instead form a uniform water film along the entire surface of the eyewear system. The micro-textured surface may be formed of a distribution of pits, protrusions, or grooves, at appropriate dimensions and gaps to create a continuously variable surface to provide at least one region along any individual droplet with a reduced contact angle between any droplet and the surface layer allow water to adhere more evenly along the surface.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a prior art lens surface;

FIG. 2 representatively illustrates a micro-textured lens surface in accordance with an exemplary embodiment of the present technology;

FIG. 3 representatively illustrates a cross-sectional detailed view of the micro-textured lens surface in accordance with an exemplary embodiment of the present technology;

FIG. 4 representatively illustrates a topographical view of the micro-textured lens surface in accordance with an exemplary embodiment of the present technology;

FIG. 5 representatively illustrates a front view of a lens having micro-textured grooves in accordance with an exemplary embodiment of the present technology;

FIG. 6 representatively illustrates a top cross-sectional view of the lens having micro-textured grooves shown in FIG. 5 in accordance with an exemplary embodiment of the present technology; and

FIG. 7 representatively illustrates a top cross-sectional view of a lens having a central depression in accordance with an exemplary embodiment of the present technology.

Elements and steps in the figures are illustrated for simplicity and clarity and have not necessarily been rendered according to any particular sequence. For example, components that may be coupled together in the manner shown or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of materials, optics, and methods for creating a surface texture along an optical surface. In addition, the present technology may be practiced in conjunction with any number of optical devices which may be subject to fogging or clouding. Further, the present technology may employ any number of conventional techniques for generating surface textures, controlling surface tension, and forming optical devices.

Referring now to FIG. 1, a prior art lens 100 having a smooth inner surface layer 102 and an outer surface layer 104 may act in a hydrophobic manner and allow droplets 106 to form on the inner surface layer 102 during use due to differing environmental conditions between the inner and outer surface layers 102, 104. Without the use of surface treatments to reduce surface tension along the inner surface payer 102, or as the result of poorly applied or aging surface treatments, droplets 106 may maintain distinct boundaries and form individual droplets 106 of varying sizes rather than spread out along the inner surface layer 102. Due to surface tension along the inner surface layer 102, these droplets 106 form spherical shapes, creating an uneven surface that disrupts optical clarity through scattering, refraction, and reflection. Droplets 106 that exist in this state resist wetting the inner surface layer 102 and result in the condition commonly referred as fogging. The individual droplets 106 may disrupt or completely block a user's vision through the lens 100.

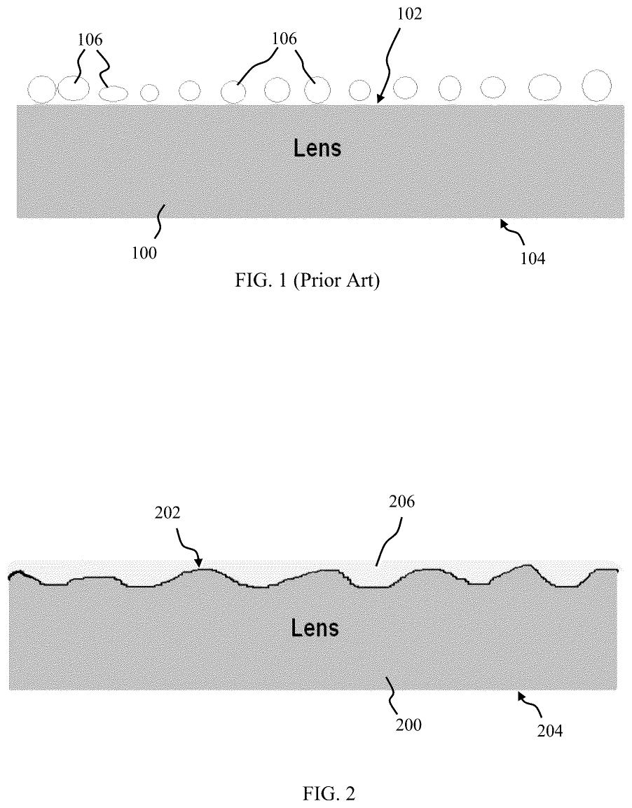

Referring now to FIG. 2, in a first embodiment, an anti-fog lens 200 may have a non-smooth inner surface layer 202 configured to create a continuously variable surface providing at least one region along any individual droplet with a reduced contact angle between that droplet and the non-smooth inner surface layer 202. The reduced contact angle is configured to encourage droplets to adhere more evenly along the entire non-smooth inner surface layer 202 to reduce or eliminate the conditions under which fogging may occur. The non-smooth inner surface layer 202 may comprise any suitable surface configured to increase the hydrophilic properties of the lens and encourage a complete wetting of the non-smooth inner surface layer 202 (Wenzel state). For example, in one embodiment, the non-smooth inner surface layer 202 may comprise a micro-textured surface formed of a distribution of pits, protrusions, or grooves, at appropriate dimensions and gaps along the inner surface layer 202 to create a continuously variable surface and provide a non-continuous contact angle between an individual droplet and the non-smooth inner surface layer 202. The continuously variable surface is intended to create an uneven surface for each droplet to reduce a likelihood of individual droplets forming an intact and distinct sphere.

As a result of the micro-textured surface, the formation of individual droplets 106 is discouraged causing a layer of moisture 206 having a more uniform top surface to form along the non-smooth inner surface layer 202. This uniform top surface of moisture 206 helps preserve a smooth film similar to how water forms a smooth, uniform film on frosted glass, making it transparent. The result is a clearer non-fogging surface through which a user can see.

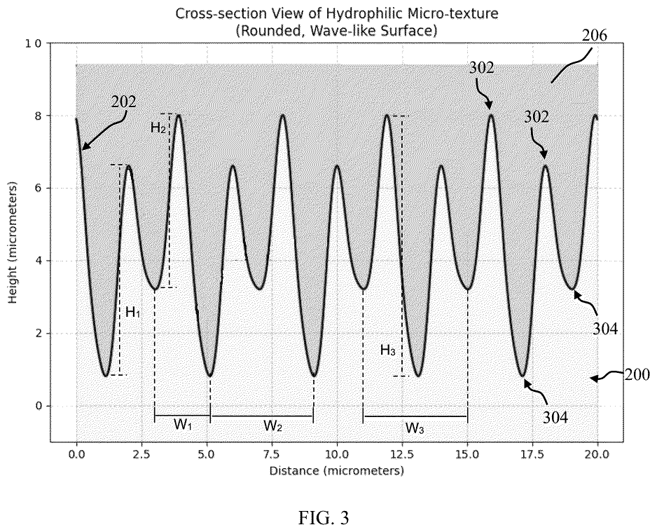

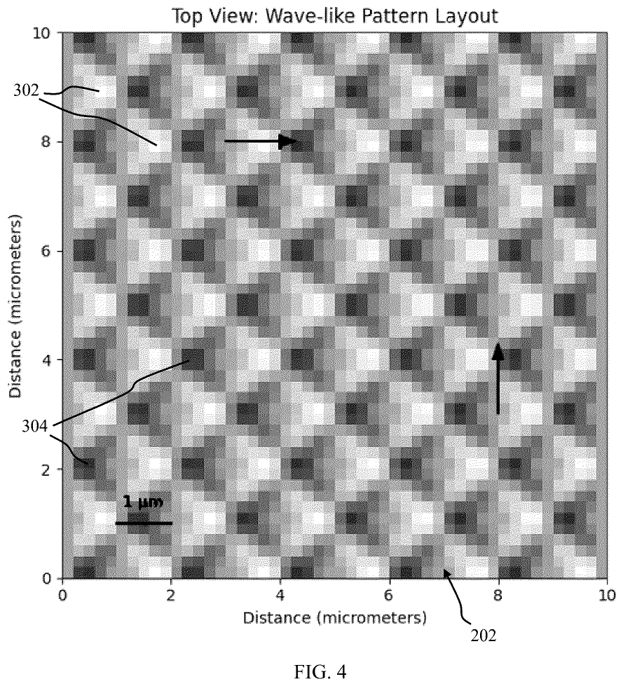

With reference now to FIG. 3, a cross-sectional view of the micro-textured surface provides a view of the varying non-smooth inner surface layer 202 across a portion of the lens 200. The non-smooth inner surface layer 202 may comprise a series of peaks 302 and troughs 304. The peaks 302 and troughs 304 may be formed in any suitable manner to form a continuously undulating surface. For example, the peaks 302 may comprise a set of high points distributed across the non-smooth inner surface layer 202 having a peak height H₁, H₂, H₃ of between about 1 micrometer and about 10 micrometers relative to an immediately adjacent trough 304. The set of high points may comprise at least two subsets of high points across the non-smooth inner surface layer 202. For example, in one embodiment, the peaks 302 may comprise a set of major peak heights and a set of minor peak heights distributed across the inner surface layer 202 of the lens 200.

The peaks 302 and the troughs 304 may also comprise curvilinear surfaces configured to provide a smooth wave-like transition from peak 302 to trough 304. The smooth transition between adjacent peaks 302 and troughs 304 may better facilitate movement of droplets 106 across the inner surface layer 202 such that they more readily form a fully wetted and uniform moisture layer 206 across the inner surface layer 202.

Distances between the peaks 302 and troughs 304 may comprise any suitable value and may form a random or repetitive pattern along the inner surface layer 202. For example, a trough-to-trough distance (period) may comprise a first width W₁ between immediately adjacent troughs 304, wherein W₁ comprises a distance of between about 0.1 micrometers and about 5 micrometers. Alternatively, the period between troughs 304 may be measured as a distance W₂ between major troughs 304 or as a distance W₃ between minor troughs 304. W₂ and W₃ may comprise the same distance or they may comprise different values according to the manner in which the peaks 302 and troughs 304 are distributed across the inner surface layer 202.

With reference now to FIG. 4, the distribution of the peaks 302 and troughs 304 across the inner surface layer 202 may form a wave-like pattern. This pattern may be configured to encourage fluids to spread across the entire inner surface layer 202. For example, the presence of peaks 302 having varying heights may promote more effective spreading of fluid across the inner surface layer 202 while also allowing fluid to flow along channels (shown as darker regions) formed by the troughs 304 between peaks 302. In one embodiment, gaps widths H₁, H₂, H₃ of between about 0.1 μm and about 5 μm may be small enough to maintain capillary action in the fluid but large enough to allow or otherwise encourage fluid flow across the inner surface layer to form the uniform moisture layer 206.

The inner surface layer 202 may be formed by any suitable method. In one representative embodiment, the inner surface layer 202 may be manufactured or otherwise formed as a surface treatment directly into the lens 200 material. In an alternative embodiment, the inner surface layer 202 may be comprised of a film adapted to be adhered to the inner surface of the lens 200 to create the continuously variable surface.

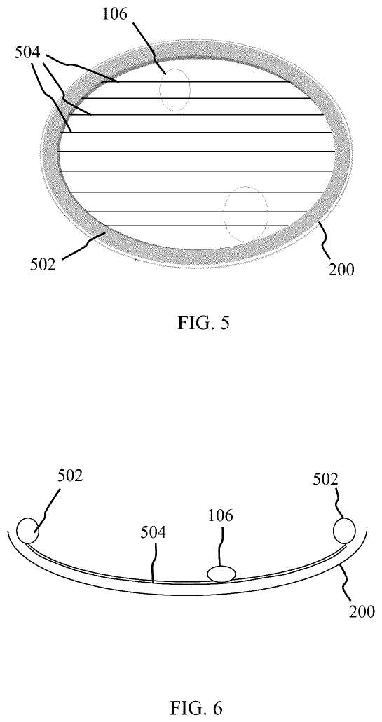

In an alternative embodiment, and referring now to FIGS. 5 and 6, the micro-textured surface of the lens 200 may include a surface treatment configured to direct water flow across the surface of the lens 200 to reduce the buildup of droplets 106 that can lead to fogging. For example, a series of channels or grooves 504 may be etched into the surface of the lens 200. During use, under the action of surface tension, a small amount of water may be allowed to roll and spread across the surface of the lens 200, absorbing and washing away the tiny droplets 106 that cause fogging. These grooves 504 are sized to be so fine that, while visible, they may be ignored by human vision and not result in any significant effect on the visual clarity of the lens 200.

To help facilitate the spreading of water across the surface of the lens 200, a water-holding structure 502 may be located around an outer perimeter of the lens 200. In one embodiment, the water-holding structure 502 may comprise a ring or multiple strips of water-holding structures are added around the edge of the lens 200. Before use, the lens 200 may be briefly submerged in water, allowing water to adhere to the micro-textured surface and fill the water-holding structure 502. Excess water may then be gently shaken off. During use, the water in the film and the water-holding structures continuously circulates, maintaining the stability of the water film on the lens 200.

The water-holding structure 502 may comprise any suitable structure or device capable of absorbing a small amount of water and becoming saturated such that some amount of water may be freely released to the surface of the lens 200. Alternatively, the water-holding structure 502 may be configured to retain a small amount of water within a channel that is free to flow from the channel to the surface of the lens 200.

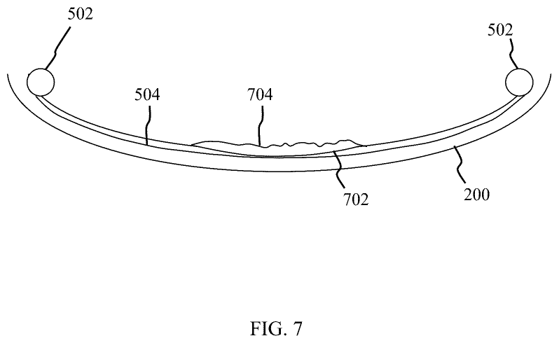

With reference now to FIG. 7, in another embodiment, a center portion of the lens 200 may be configured with a slight depression 702 that is configured to allow a small amount of water 704 to pool at the center portion of the lens 200 when it is held in a horizontal position. When the lens 200 is turned to a vertical position, the micro-textured surface of the lens 200 may help improve surface tension effects on the pooled water 704 to allow flow across the surface of the lens 200 rather than simply run downwards to the bottom of the lens 200. The amount of pooled water 704 may be sufficient to help create the uniform moisture layer 206 across the inner surface layer 202 of the lens 200.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to a preferred embodiment. However, changes and modifications may be made to the preferred embodiment without departing from the scope of the present invention. These and other changes or modifications are intended to be included within the scope of the present technology, as expressed in the following claims.

1. An anti-fogging lens for preventing individual water droplet formation, comprising:
a lens having an outer surface and an inner surface, wherein the inner surface comprises a continuously variable surface configured to:
create a reduced contact angle between a water droplet and the inner surface; and
encourage a complete wetting of the inner surface.

2. An anti-fogging lens according to claim 1, wherein the continuously variable surface comprises a micro-textured surface.

3. An anti-fogging lens according to claim 2, wherein micro-textured surface is formed of at least one of a distribution of pits, protrusions, and grooves.

4. An anti-fogging lens according to claim 2, wherein the micro-textured surface comprises a series of peaks and troughs distributed across the inner surface.

5. An anti-fogging lens according to claim 4, wherein each peak from the series of peaks comprises a peak height of between about 1 micrometer and about 10 micrometers relative to an immediately adjacent trough.

6. An anti-fogging lens according to claim 4, wherein the series of peaks and troughs comprise curvilinear surfaces configured to provide a smooth wave-like transition from peak to trough.

7. An anti-fogging lens according to claim 4, wherein a distance between adjacent troughs is between about 0.1 micrometers and about 5 micrometers.

8. An anti-fogging lens according to claim 1, wherein the fully wetted inner surface comprises a uniform moisture layer extending across the inner surface.

9. An anti-fogging lens according to claim 1, further comprising a series of grooves extending across the inner surface, wherein the inner grooves are configured to encourage a flow of water across the inner surface to form the wetted inner surface.

10. An anti-fogging lens according to claim 1, further comprising a water-holding structure disposed along an outer perimeter of the inner surface of the lens.

11. An anti-fogging lens for preventing individual water droplet formation, comprising:
a lens having an outer surface and an inner surface, wherein the inner surface comprises a series of peaks and troughs arranged to create an undulating surface configured to:
create a reduced contact angle between a water droplet and the inner surface; and
encourage a complete wetting of the inner surface.

12. An anti-fogging lens according to claim 11, wherein the undulating surface provides a non-continuous contact angle between an individual droplet and the inner surface.

13. An anti-fogging lens according to claim 11, wherein the series of peaks comprises a set of high points distributed across the inner surface.

14. An anti-fogging lens according to claim 13, wherein the set of high points may comprise at least two subsets of high points across the non-smooth inner surface, wherein:
a first set of high points form a set of major peaks; and
a second set of high point form a set of minor peaks.

15. An anti-fogging lens according to claim 11, wherein the series of peaks and troughs comprise curvilinear surfaces configured to provide a smooth wave-like transition from peak to trough.

16. An anti-fogging lens according to claim 11, wherein the series of peaks and troughs form a repetitive wave-like pattern along the inner surface.

17. An anti-fogging lens according to claim 11, further comprising a series of grooves extending across the inner surface, wherein the inner grooves are configured to encourage a flow of water across the inner surface to form the wetted inner surface.

18. An anti-fogging lens according to claim 11, further comprising a water-holding structure disposed along an outer perimeter of the inner surface of the lens.
